(19) United States
(12) Patent Application Publication
(10) Pub. No.: US 2009/0107406 A1
(43) Pub. Date: Apr. 30, 2009

(54) Feeding Bowl with Extension Handle

(76) Inventor: Martin Penny, Whitestone, NY (US)

Correspondence Address: The Law Office of Frank V. DeRosa, PC., 2005 Merrick Road, Suite 329, Merrick, NY, 11566, US

(21) Appl. No.: 12/172,215

(22) Filed: Jul. 11, 2008

Related U.S. Application Data
(60) Provisional application No. 60/949,235, filed on Jul. 11, 2007.

(51) Int. Cl. A01K 1/10; A01K 5/00

(52) U.S. Cl. 119/51.5; 119/61.56; 119/51.01

(57) ABSTRACT

Animal feeding bowls and in particular, an animal feeding bowl having adjustable extension handle removably attached to the feeding bowl, wherein the extension handle extends upward from the feeding bowl to a height that makes it easy for a physically handicapped individual to maneuver the feeding bowl without bending, for example.

### CROSS-REFERENCE TO RELATED APPLICATION

This application claims priority to U.S. Provisional Patent Application No. 60/949,235, filed on Jul. 11, 2007, which is fully incorporated herein by reference.

### TECHNICAL FIELD

The invention relates to animal feeding bowls and in particular, an animal feeding bowl having adjustable extension handle removably attached to the feeding bowl, wherein the extension handle extends upward from the feeding bowl to a height that makes it easy for a physically handicapped individual to maneuver the feeding bowl without bending, for example.

### BACKGROUND

Individuals that are physically challenged or elderly people with no physical impairments but with limited bending mobility may have difficulty feeding their pets when having to bend down to pick up the bowls for cleaning or putting water and food in the bowls.

### SUMMARY OF THE INVENTION

Exemplary embodiment of the invention relate to animal feeding bowls and in particular, an animal feeding bowl having adjustable extension handle removably attached to the feeding bowl, wherein the extension handle extends upward from the feeding bowl to a height that makes it easy for a physically handicapped individual to maneuver the feeding bowl without bending, for example.

These and other exemplary embodiments and features of the present invention will become apparent from the following detailed description considered in connection with the accompanying drawings.

### BRIEF DESCRIPTION OF THE DRAWINGS

FIG. 1 is a schematic perspective view of a feeding bowl according to an exemplary embodiment of the invention.

FIG. 2 is a schematic perspective view of a feeding bowl according to another exemplary embodiment of the invention.

FIGS. 3A and 3B are schematic perspective views of the exemplary feeding dish of FIG. 2.

FIGS. 4A and 4B are schematic front and back views of a portion of an extension handle according to an exemplary embodiment of the invention.

FIGS. 5A and 5B are schematic front and back views of a portion of an extension handle according to another exemplary embodiment of the invention.

FIG. 6 is an enlarged view of the coupling end (50) framework of a handle portion according to an exemplary embodiment of the invention.

FIG. 7 is a schematic perspective view of a removable bowl having an upper rim.

### DETAILED DESCRIPTION OF EXEMPLARY EMBODIMENTS

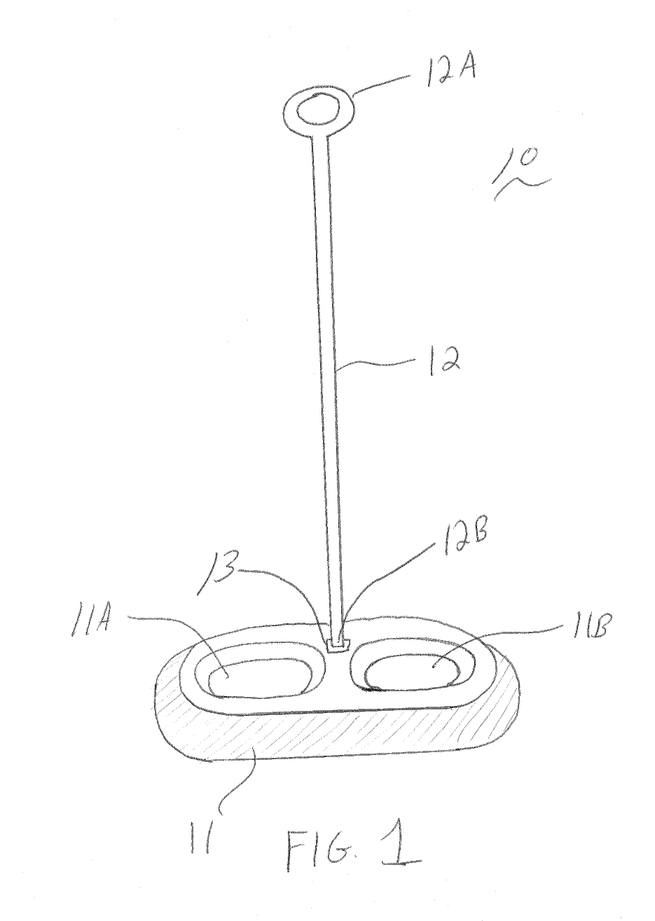

FIG. 1 is a schematic perspective view of a feeding bowl according to an exemplary embodiment of the invention. In particular, FIG. 1 schematically illustrates a general framework of a feeding bowl (10) comprising a feeding dish (11) comprising a first bowl (11a) and second bowl (11b), an extension handle (12) comprising a handle (12a) on a top end, and a bottom end (12b) that is coupled to the feeding dish (11) via a coupling mechanism (13). The feeding dish (11) can be made of plastic or other suitable materials that can be molded, for example. The exemplary feeding dish (11) is shown as a two-bowl dish, although the feeding dish may have only one bowl or more than two bowls.

The extension handle (12) can be removably coupled or permanently coupled to the feeding dish (11) depending on the framework of the coupling mechanism (13). For instance, the coupling mechanism (13) can be any type of a connecting device such as, a quick snap device, a screw on device, an insert, twist, and turn to secure device, or a device that has a release mechanism embedded or attached to the extension handle.

The extension handle (12) can be a fixed length or adjustable. In FIG. 1, the extension handle (12) is depicted as a one-piece handle having a fixed length between the top handle end (12a) and the bottom end (12b) that is coupled to the feeding dish (11) via the coupling mechanism (13). The extension handle (12) may be made from any suitable materials such as plastic, aluminum, or any other similar material but any weight material will work. The top handle (12a) of the extension handle (12) can form to any kind of shape for example, a “T”, a knob or a circle.

With the above design, the feeding bowl can advantageously be used by, for example, elderly people, physically challenged people, people with back problems or people who have trouble bending over or people with no physical problems who simply do not want to bend over to feed their pet(s).

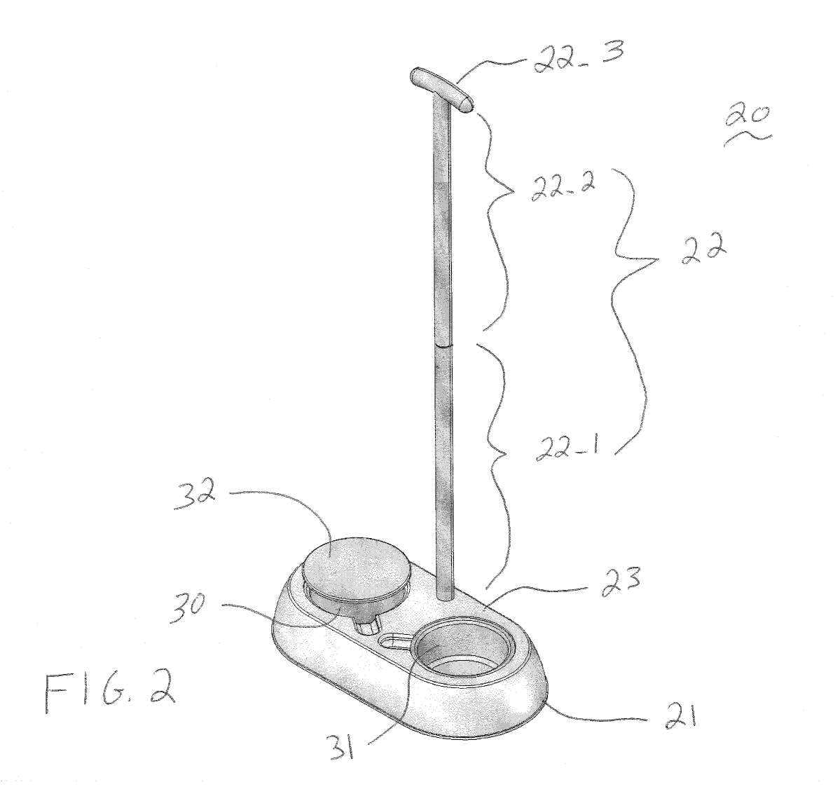

FIG. 2 is a schematic perspective view of a feeding bowl according to an exemplary embodiment of the invention. In particular, FIG. 2 schematically illustrates a feeding bowl (20) comprising a feeding dish (21) comprising a first removable bowl (30) and second removable bowl (31), an extension handle (22) comprising a first portion (22_1) and second portion (22_2) and handle (22_3) formed on a top end of the second portion (22_2). The bottom end of the first portion (22_1) of the handle (22) is removably coupled to the feeding dish (21) via a coupling mechanism (23) as will be explained below.

The exemplary feeding bowl (20) of FIG. 2 has a framework based on the feeding bowl (10) of FIG. 1, except that the feeding dish (21) has removable bowls (30, 31) with lids (32) for ease of cleaning and refrigerated storage of food, for example. Moreover, the extension handle (22) in FIG. 2 is a multi-piece handle (22), wherein the various portions (22_1) and (22_2) can be coupled and decoupled to realize an extension handle (22) with variable heights. As explained below, the handle portions (22_1) and (22-2) are designed to be removably coupled to each other (and other possible handle portions similar in design to portion (22_1), and the bottom portions of each of the handle portions (22_1) and (22-2) are designed to mechanically mate to the ends of other handle portions and to the coupling mechanisms (23) of the feeding dish (21).

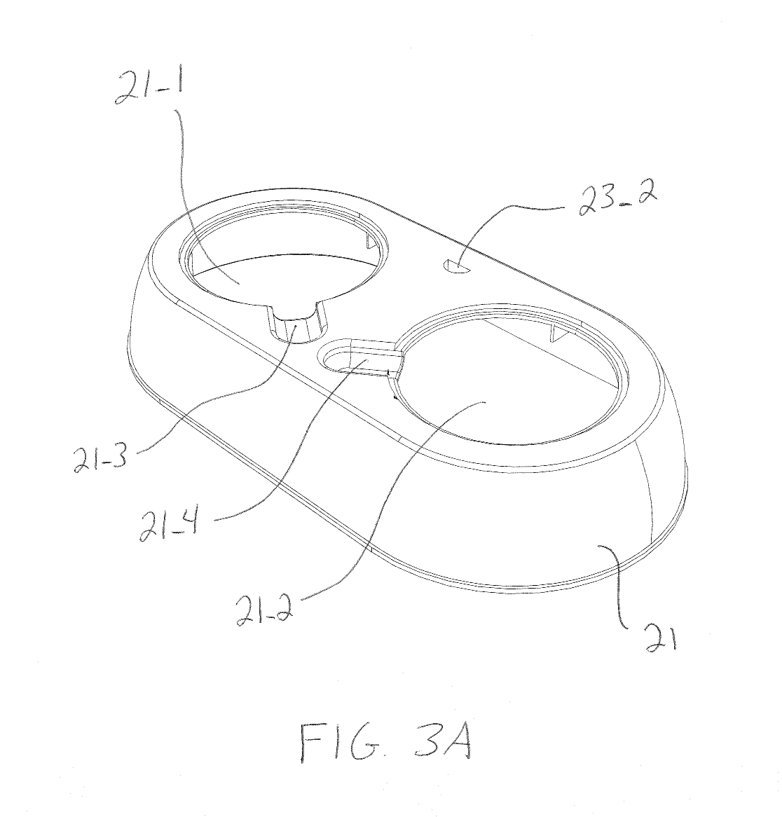

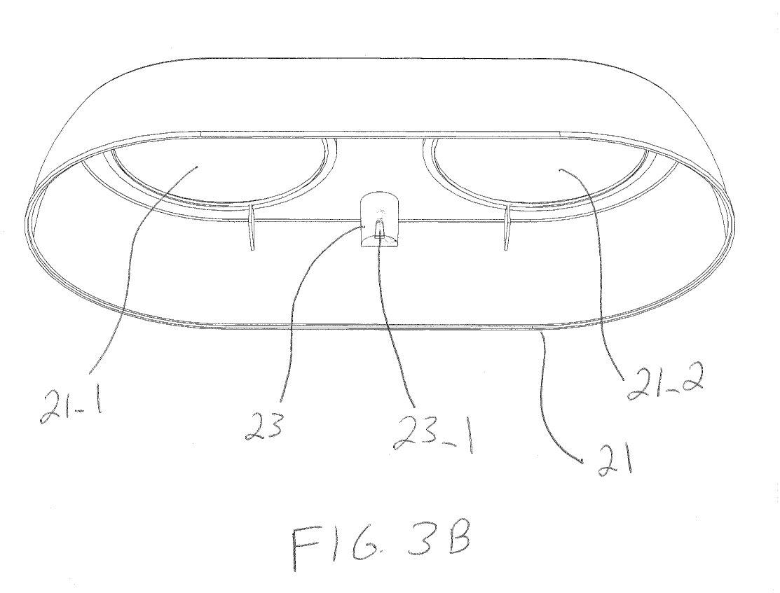

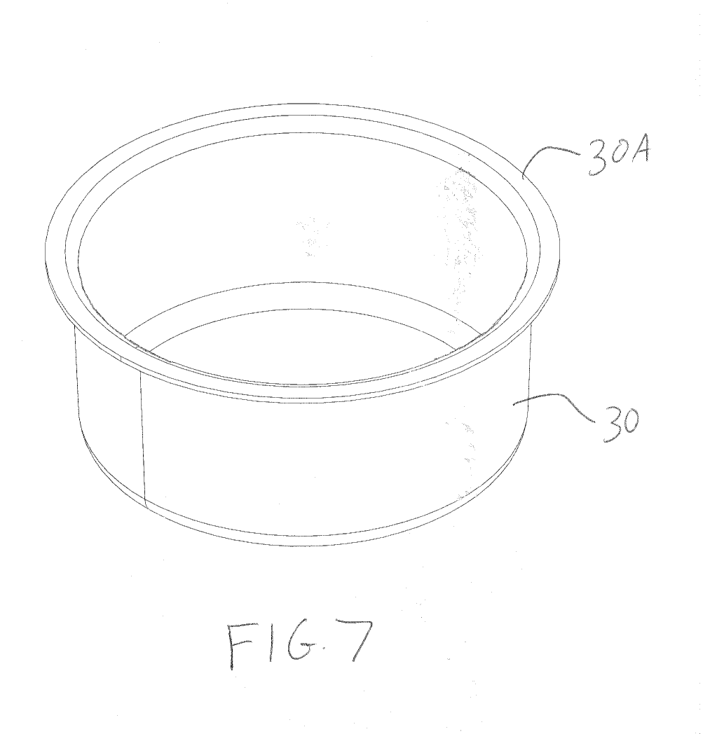

FIGS. 3A and 3B are schematic perspective views of the exemplary feeding dish (21) of FIG. 2. As shown in FIGS. 3A and 3B, the feeding dish (21) includes apertures (21_1) and (21_2) to receivably insert removable bowls (30) and (31) (wherein the removable bowls (30) and (31) of FIG. 2 are not shown in FIGS. 3A and 3B). FIG. 7 is a schematic perspective view of a removable bowl (30) having an upper rim (30a). With the removable bowl (30) is inserted in the aperture (21_1), for example, the feeding dish (21) includes indents (21_3) and (21-4) that allow a person to slip his/her finger under the rim (30a) of the removable bowl (30) and push up on the rim to lift the bowl (30).

FIG. 3A is a top perspective view of the feeding dish (21) shown with the feeding bowls (30) and (31) removed. FIG. 3B is a bottom perspective view of the feeding dishes (21) showing an interior region of the bowl from the perspective of the bottom opening. As depicted in FIGS. 3A and 3B, the coupling mechanism (23) of the feeding dish (21) includes a semi-circular shaped retaining member (23) having an aperture (23_2) (FIG. 3A) formed on the top surface of the feeding dish (21) and an open slot (23_1) formed on a sidewall of the retaining member (23) (FIG. 3B). The coupling mechanism (23) is designed to mateably connect to coupling ends of the handle portions (22_1) and (22_2), as explained hereafter.

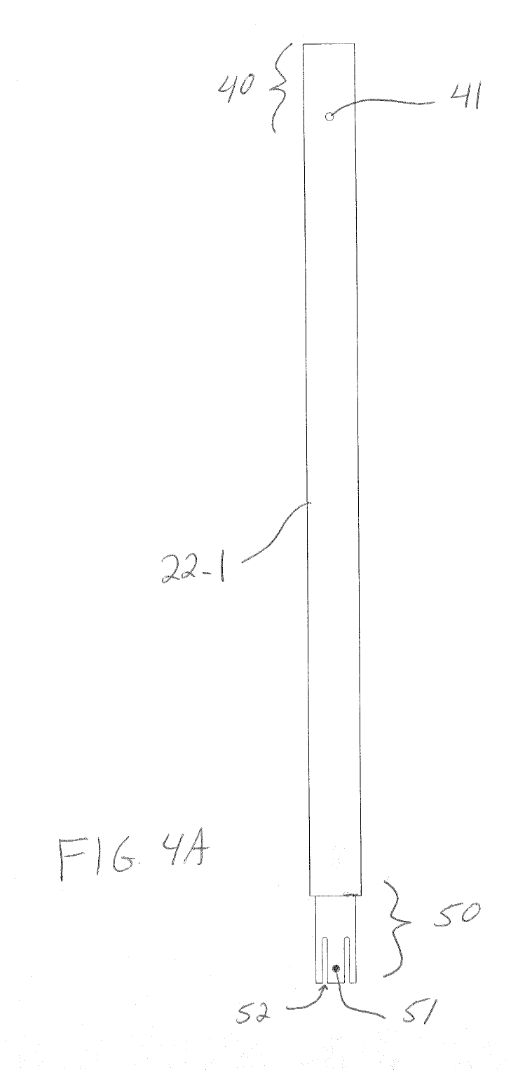

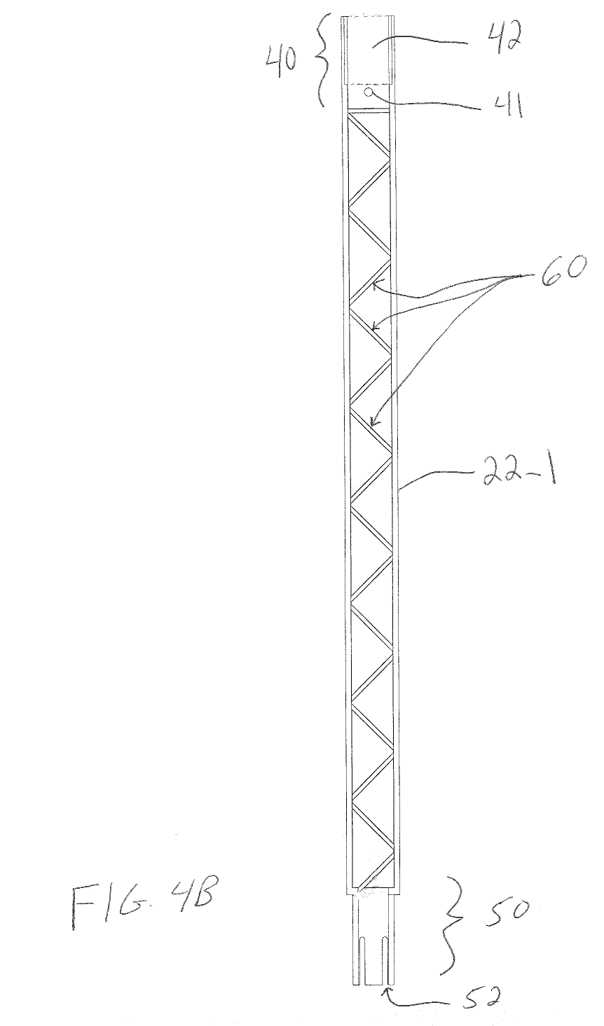

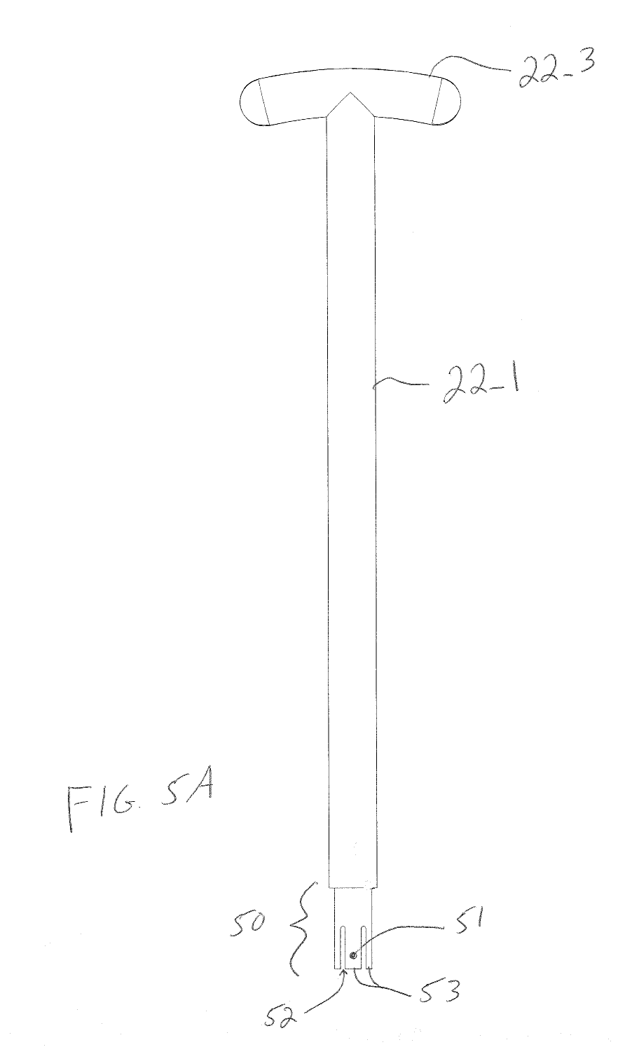

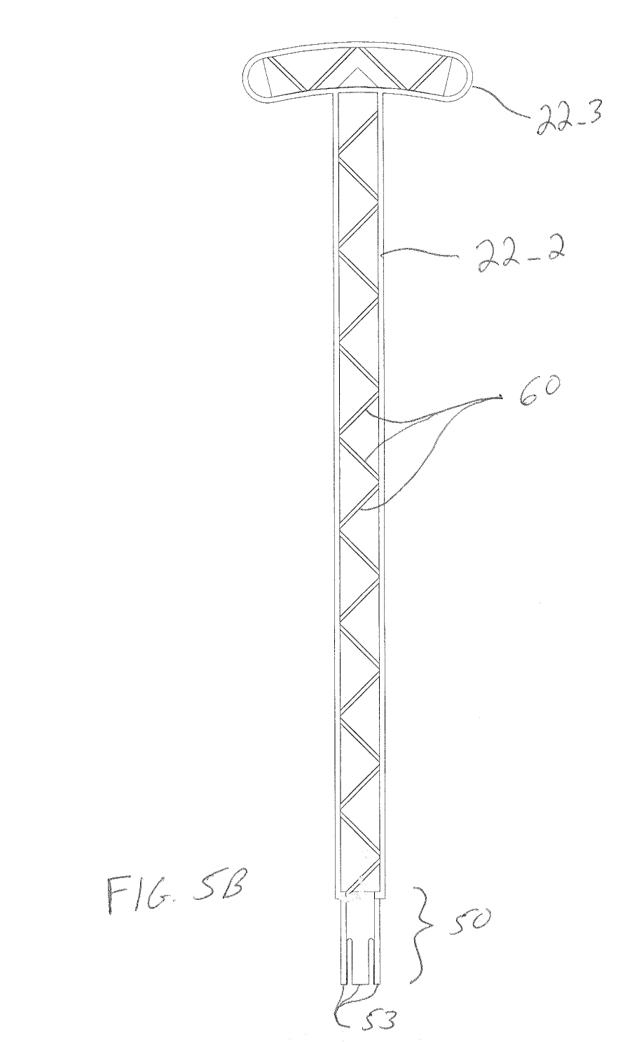

FIGS. 4A and 4B are schematic front and back views of a portion of an extension handle according to an exemplary embodiment of the invention, and FIGS. 5A and 5B are schematic front and back views of a portion of an extension handle according to another exemplary embodiment of the invention. In particular, FIGS. 4A and 4B illustrate an exemplary framework of the handle portion (22_1) of FIG. 2, while FIGS. 5A and 5B illustrate an exemplary framework of the handle portion (22_2) of FIG. 2.

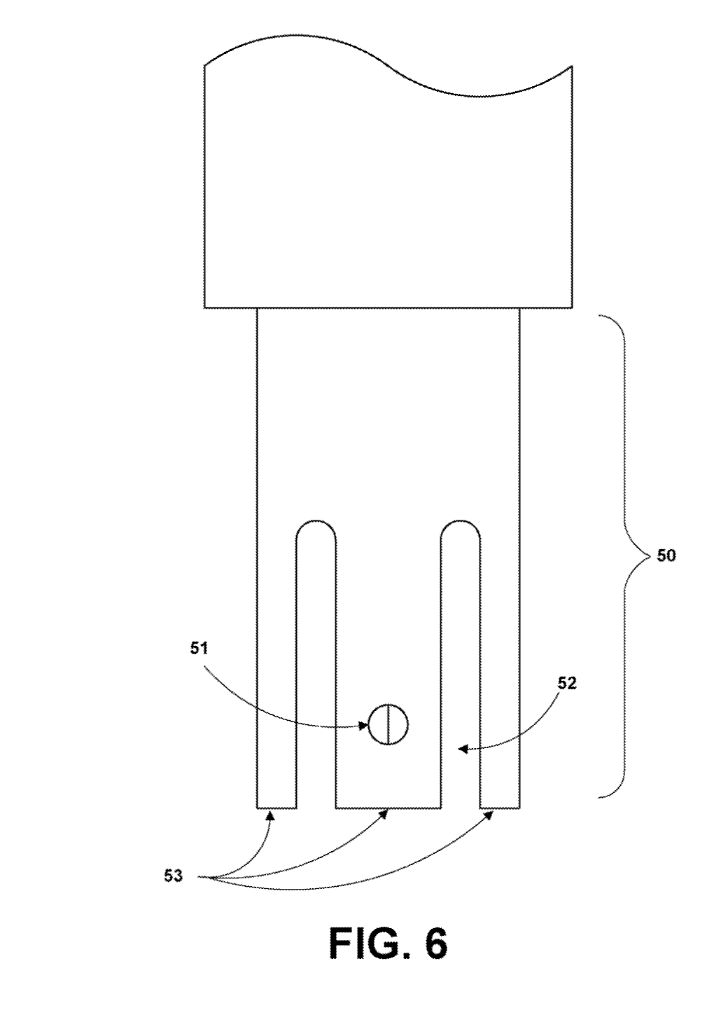

FIG. 4A illustrates a front perspective view of the handle portion (22_1) comprising a first coupling end (40) and a second coupling end (50). FIG. 4B is a back perspective view of the handle portion (22_1). FIGS. 4A ad 4B illustrate that the handle portion (22_1) is a semi-circular shaped hollow elongated member, wherein supporting ridge structure (60) is formed in the inner region of the handle portion (22_1). As shown in FIGS. 4A and 4B, the coupling end (40) comprises an aperture (41) formed through the surface of the handle portion (22_1) and a flat plate (42) (shown in phantom in FIG. 4B coupled to the backside of the top end of the handle portion (22-1) to form a coupling chamber. The coupling end (50) includes semi circular shaped structure that is narrower (tapered) that the elongated body of the handle portion (22_1), wherein the coupling end (50) includes a plurality of elongated slots (52) defining flexible fin embers (53), and a pimple (51) member formed on a surface of the middle fin member (53). FIG. 6 is an enlarged view of the coupling end (50) framework of a handle portion according to an exemplary embodiment of the invention. The coupling end (50) is designed to mateably couple with a coupling end (40) of another handle portion so that one or more elongated handle portions can be coupled to have a variable length extension handle. Moreover, the coupling end (40) is designed to mateably couple with the coupling mechanism 23 of the feeding dish (21). The coupling end (50) is a male mating structure that is designed to be inserted in the retaining chamber (female end) of the coupling end (40), wherein the pimple structure (51) is designed to engage the aperture (41) and lock the coupling ends (40) and (50) in place. In this design, the elongate slots (52) are designed to provide flexible fin members, wherein the fin member (53) with the pimple (51) can be flexed when the pimple engages and disengages the aperture (41) of the coupling end (40). An individual can decouple two handle portions by pushing the pimple (51) through the aperture (41) and pulling the two coupled handle portions apart.

FIG. 5A illustrates a front perspective view of the handle portion (22_2) comprising the handle end (22_3) and a second coupling end (50). FIG. 5B is a back perspective view of the handle portion (22_2). Similar to FIGS. 4A and 4B, the handle portion (22_2) is a semi-circular shaped hollow elongated member, wherein supporting ridge structure (60) is formed in the inner region of the handle portion (22_2). The coupling end (50) of the handle portions (22_1) and (22_1) are designed to mateably engage the coupling end (40) of another handle portion or the coupling mechanism (23) of the feeding dish (21) (FIG. 3B). In this manner, the length of the extension handle (22) can be varied by directly coupling the handle portion (22_2) to the feeding dish (21) or connecting the handle portion (22_2) to another extended handle portion (22_1), which can be coupled to the feeding dish (21) via the mating connection (23) or another extension handle portion (22_1_.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention. All such changes and modifications are intended to be included within the scope of the invention as defined by the appended claims.

I claim:

1. A pet feeding apparatus, comprising a base and an elongated handle formed of a plurality of handle portions, that are removably coupled to vary a height of the extension handle.
